(19) United States
(12) Patent Application Publication
(10) Pub. No.: US 2020/0086686 A1
(43) Pub. Date: Mar. 19, 2020

(54) TIRE FOR A VEHICLE CARRYING HEAVY LOADS, COMPRISING A NEW TREAD

(71) Applicant: COMPAGNIE GENERALE DES ETABLISSEMENTS MICHELIN, Clermont-Ferrand (FR)

(72) Inventors: Etienne FLEURY, Clermont-Ferrand Cedex 9 (FR); Akhilesh GARG, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/471,324

(22) PCT Filed: Dec. 20, 2017
(86) PCT No.: PCT/FR2017/053743

§ 371 Date: Jun. 19, 2019

(30) Foreign Application Priority Data
Dec. 20, 2016 (FR) 1662905

(51) Int. Cl. B60C 1/00; C08L 25/10; C08L 51/04; C08L 9/00; C08L 7/00; C08K 3/013; C08K 3/04; C08K 3/36; C08K 5/00; C08K 5/01; C08K 5/548

(52) U.S. Cl. CPC B60C 1/0016; C08L 25/10; C08L 51/04; C08L 9/00; C08L 7/00; C08K 3/013; C08L 2205/02; C08K 3/36; C08K 5/0025; C08K 5/01; C08K 5/548; B60C 2200/06; C08K 3/04

(57) ABSTRACT

A tire intended to equip a vehicle bearing heavy loads, which includes a tread having at least one rubber composition is provided. The rubber composition is based on at least one elastomer matrix predominantly comprising a copolymer based on styrene and butadiene, a reinforcing filler predominantly comprising silica, a chemical crosslinking system, an agent for coupling between the elastomer matrix and the reinforcing filler, a plasticizing system, and an agent for modifying the copolymer based on styrene and butadiene. The modifying agent is a 1,3-dipolar compound of general formula (I):

A-E-D (I)
D represents a functional group comprising at least one nitrogen atom and being capable of bonding to the copolymer via a cycloaddition of [3+2] type on a carbon-carbon double bond of the chain of the copolymer,
E represents a divalent spacer group connecting group D to group A,
A represents a functional group.

This application is a 371 national phase entry of PCT/FR2017/053743 filed on 20 Dec. 2017, which claims benefit of French Patent Application No. 1662905, filed 20 Dec. 2016, the entire contents of which are incorporated herein by reference for all purposes.

### BACKGROUND

### 1. Technical Field

The field of the present invention is that of tires for vehicles bearing heavy loads, in particular heavy-duty vehicles, buses, civil engineering vehicles, etc.

### 2. Related Art

Their tires intended for vehicles bearing heavy loads have specific dimensional, robustness and structural features which distinguish them from other tires, in particular from tires for equipping passenger vehicles. Their treads must comply with a large number of technical performance qualities that are often contradictory, in particular high wet grip, low rolling resistance and good wear strength.

Specifically, certain vehicles bearing heavy loads are intended to run over increasingly long journeys, because of improvements to the road network and the growth of motorway networks worldwide. For safety reasons, the wet grip must be high. Moreover, the wear of these tire treads must be as low as possible, as must the rolling-related energy losses.

However, it is well known to a person skilled in the art that the improvement in one performance quality for tires is often obtained to the detriment of the other performance qualities.

For example, one way of giving a tire high wet grip is to use, for the tread, a rubber composition which has a good hysteretic potential. However, at the same time, this tread must have the lowest possible contribution to the rolling resistance to limit the rolling-related energy losses; i.e. it must have the least possible hysteresis.

Another example of contradictory performance qualities is the following. To improve the wear strength, a person skilled in the art knows that it is necessary for the tread to have good stiffness. Such stiffness may be obtained especially by increasing the content of reinforcing filler in the rubber compositions which constitute these treads. However, increasing this content of reinforcing fillers gives rise to an increase in the hysteresis of the tire and thus a risk of penalizing the rolling resistance properties.

There is thus an ongoing need to provide a tire for vehicles bearing heavy loads having a tread whose wet grip is high, without the rolling resistance and the wear strength being penalized.

### SUMMARY

In the light of the foregoing, one object is to provide a tire intended to equip a vehicle bearing heavy loads, this tire including a tread which satisfies a compromise of wet grip/rolling resistance/wear strength performance qualities.

The Applicants have discovered in the course of their research that the specific combination of a copolymer based on styrene and butadiene, said copolymer being modified with a specific modifying agent, of a reinforcing filler predominantly comprising silica and of a plasticizing system at a specific content makes it possible to obtain a rubber composition which can be used in the tread of a tire for vehicles bearing heavy loads, which satisfies this problem.

Thus, the invention relates to a tire intended to equip a vehicle bearing heavy loads, this tire including a tread having at least one rubber composition based on at least:
an elastomer matrix predominantly comprising a copolymer based on styrene and butadiene having a glass transition temperature Tg strictly above −65° C. and below or equal to −30° C.,
a reinforcing filler predominantly comprising silica,
a chemical crosslinking system,
an agent for coupling between the elastomer matrix and the reinforcing filler,
a plasticizing system comprising from 2 to 15 phr, preferably from 2 to 10 phr, of at least one plasticizing resin having a glass transition temperature Tg of greater than or equal to 20° C., and of which the total content of the plasticizing system in the composition ranges from 2 to 17 phr, preferably from 2 to 12 phr, and
an agent for modifying said copolymer based on styrene and butadiene, optionally already grafted onto said copolymer, said modifying agent being a 1,3-dipolar compound of general formula (I):

A-E-D (I)
the symbol D represents a functional group comprising at least one nitrogen atom and being capable of bonding to said copolymer via a cycloaddition of [3+2] type on a carbon-carbon double bond of the chain of said copolymer,
the symbol E represents a divalent spacer group connecting group D to group A,
A represents a functional group chosen from C₁-C₂₀ alkyls, C₇-C₁₈ alkylaryls, C₇-C₁₈ arylalkyls, optionally substituted nitrogen-based heterocycles of 5 to 6 atoms, optionally substituted sulfur-based heterocycles of 5 to 6 atoms, ester groups, phosphate groups, dialkylamino groups and associative groups comprising at least one nitrogen atom.

Preferentially, the functional group D of the modifying agent comprises a nitrile oxide function, a nitrone function or a nitrile imine function.

Preferentially, the spacer group E is a linear or branched C₁-C₂₄, preferably C₁-C₁₀, alkyl chain optionally comprising one or more heteroatoms chosen from nitrogen, sulfur and oxygen atoms.

Preferentially, group D of the modifying agent is a group of formula (II):

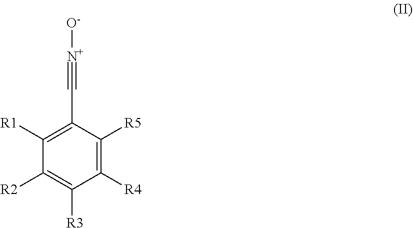

in which:
R1, R2, R3, R4, R5, which may be identical or different, represent a hydrogen atom, a halogen atom, a C₁-C₅ alkyl, a C₁-C₅ alkoxyl or a covalent bond enabling attachment to the spacer group E;
on condition that at least one from among R1, R2, R3, R4 and R5 represents said covalent bond.

Preferentially, group A is an associative group comprising at least one nitrogen atom, said associative group being chosen from formulae (IV) to (VIII) below:

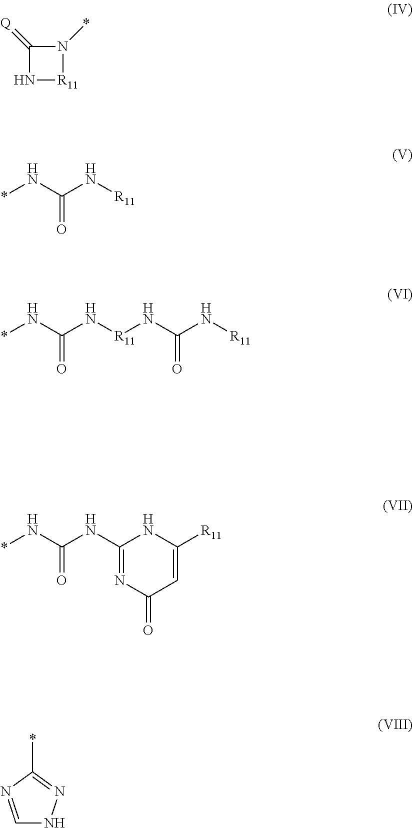

in which:
R11 represents a hydrocarbon-based group that may optionally contain heteroatoms,
Q represents an oxygen or sulfur atom or NH, preferably an oxygen atom, and
the symbol * represents the attachment to the spacer group E.

Preferentially, the modifying agent is chosen from the compounds of formulae (IX) to (XVIII) below and the mesomeric forms thereof:

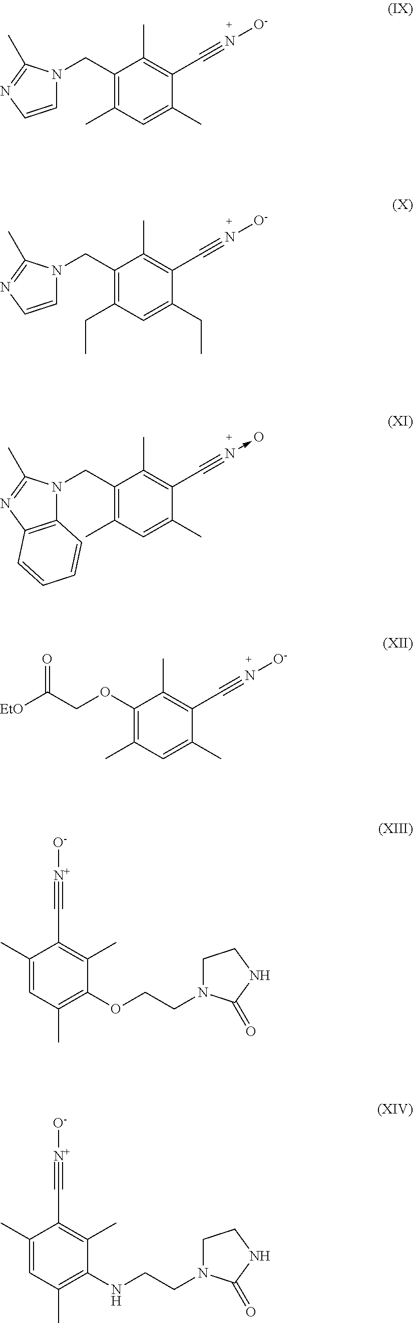

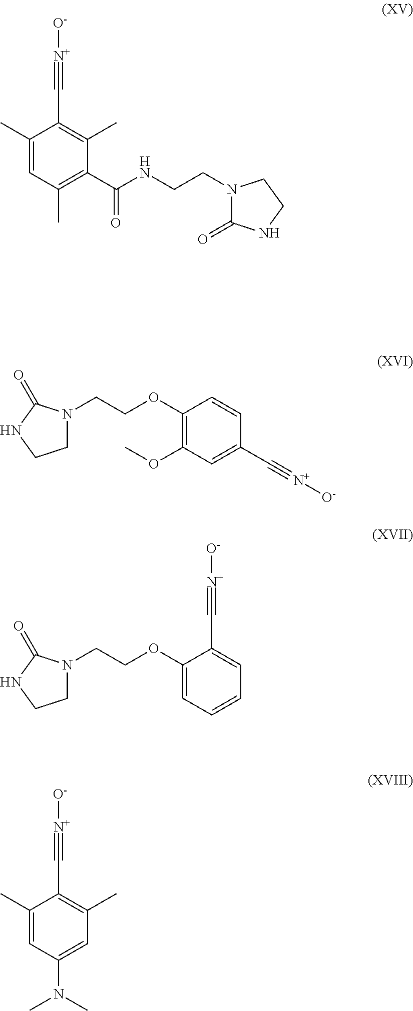

More preferentially, the modifying agent is chosen from the compounds of formulae (XIII), (XIV), (XV) and (XVII) and the mesomeric forms thereof.

Preferentially, the content of modifying agent of formula (I) in the composition ranges from 0.01 mol % to 50 mol %, preferably from 0.01 mol % to 5 mol % and more preferentially from 0.01 mol % to 3 mol %.

Preferentially, the copolymer based on styrene and butadiene has a glass transition temperature ranging from −60° C. to −40° C.

Preferentially, the copolymer based on styrene and butadiene is constituted of styrene monomers and of butadiene monomers.

Preferentially, the elastomer matrix also comprises at least one second diene elastomer different from the copolymer based on styrene and butadiene.

Preferentially, the second diene elastomer is chosen from the group formed by polybutadienes, natural rubber, synthetic isoprenes, butadiene copolymers other than butadiene-styrene copolymers, isoprene copolymers and mixtures of these polymers and copolymers; preferably the second diene elastomer is a polybutadiene.

Preferentially, the content of the second diene elastomer ranges from 5 to 49 phr, preferably from 15 to 35 phr.

Preferentially, the composition also comprises carbon black.

Preferentially, the content of the reinforcing filler ranges from 55 to 200 phr, preferably from 55 to 150 phr, more preferably from 55 to 80 phr.

Preferentially, the plasticizing resin has a glass transition temperature Tg of greater than or equal to 30° C., preferably ranging from 30 to 100° C.

Preferentially, the plasticizing resin is chosen from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, mixtures of C₅ fraction homopolymer or copolymer resins and of C₉ fraction homopolymer or copolymer resins, α-methylstyrene homopolymer or copolymer resins, and mixtures of these resins.

Preferentially, the plasticizing system comprises from 0 to 2 phr of at least one plasticizing agent that is liquid at room temperature.

Preferentially, the composition is free of a plasticizing agent that is liquid at room temperature.

Preferentially, the tire as defined above is intended to equip a heavy-duty vehicle or a bus.

### I—DETAILED DESCRIPTION OF EXAMPLE EMBODIMENTS

The invention relates to a tire intended to equip a vehicle bearing heavy loads, this tire comprising a tread including at least one rubber composition based on at least:
an elastomer matrix predominantly comprising a copolymer based on styrene and butadiene having a glass transition temperature Tg strictly above −65° C. and below or equal to −30° C.,
a reinforcing filler predominantly comprising silica,
a chemical crosslinking system,
an agent for coupling between the elastomer matrix and the reinforcing filler,
a plasticizing system comprising from 2 to 15 phr, preferably from 2 to 10 phr, of at least one plasticizing resin having a glass transition temperature Tg of greater than or equal to 20° C., and of which the total content of the plasticizing system in the composition ranges from 2 to 17 phr, preferably from 2 to 12 phr, and
an agent for modifying said copolymer based on styrene and butadiene, optionally already grafted onto said copolymer, said modifying agent being a 1,3-dipolar compound of general formula (I):

A-E-D (I)
the symbol D represents a functional group comprising at least one nitrogen atom and being capable of bonding to said copolymer via a cycloaddition of [3+2] type on a carbon-carbon double bond of the chain of said copolymer,
the symbol E represents a divalent spacer group connecting group D to group A,
A represents a functional group chosen from C₁-C₂₀ alkyls, C₇-C₁₈ alkylaryls, C₇-C₁₈ arylalkyls, optionally substituted nitrogen-based heterocycles of 5 to 6 atoms, optionally substituted sulfur-based heterocycles of 5 to 6 atoms, ester groups, phosphate groups, dialkylamino groups and associative groups comprising at least one nitrogen atom.

In the present description, unless expressly indicated otherwise, all the percentages (%) shown are percentages by weight.

Furthermore, any range of values denoted by the expression “between a and b” represents the range of values extending from more than “a” to less than “b” (that is to say, limits a and b excluded), while any range of values denoted by the expression “from a to b” means the range of values extending from “a” up to “b” (that is to say, including the strict limits a and b).

The abbreviation “phr” (per hundred parts of rubber) means parts by weight per hundred parts of elastomers (of the total of the elastomers, if several elastomers are present) or rubber present in the rubber composition.

The term “tire intended to equip a vehicle bearing heavy loads” generally means any tire intended to equip heavy-duty vehicles, buses, civil engineering vehicles, agricultural vehicles or aeroplanes. The invention is particularly well suited to tires intended to equip heavy-duty vehicles or buses.

The term “rubber composition based on” should be understood as meaning a rubber composition including the mixture and/or the reaction product of the various constituents used, some of these base constituents being capable of reacting, or intended to react, with one another, at least in part, during the various phases of manufacture of the composition, in particular during the crosslinking or vulcanization thereof.

The term “elastomer matrix” or “elastomeric matrix” means all of the elastomer(s) present in the rubber composition.

The term “elastomer” (or, equally, rubber), whether natural or synthetic, should be understood to mean an elastomer consisting at least in part (that is to say a homopolymer or a copolymer) of diene monomer(s) (i.e. monomer(s) bearing two conjugated or non-conjugated carbon-carbon double bonds). These elastomers are also referred to as diene elastomers.

These diene elastomers can be classified into two categories: “essentially unsaturated” or “essentially saturated”. “Essentially unsaturated” generally refers to a diene elastomer resulting at least in part from conjugated diene monomers having a content of units of diene origin (conjugated dienes) which is greater than 15% (molar percentage); thus it is that diene elastomers such as butyl rubbers or copolymers of dienes and of alpha-olefins of EPDM type do not come within the preceding definition and can in particular be described as “essentially saturated” diene elastomers (low or very low content, always less than 15 mol %, of units of diene origin). In the category of “essentially unsaturated” diene elastomers, the term “highly unsaturated” diene elastomer refers in particular to a diene elastomer having a content of units of diene origin (conjugated dienes) which is greater than 50% (molar percentage).

Given these definitions, the term “diene elastomer that can be used in the compositions in accordance with the invention” more particularly means:

(a)—any homopolymer of a conjugated diene monomer, in particular any homopolymer obtained by polymerization of a conjugated diene monomer containing from 4 to 12 carbon atoms;
(b)—any copolymer obtained by copolymerization of one or more conjugated dienes with each other or with an ethylene monomer or with one or more vinylaromatic compounds containing from 8 to 20 carbon atoms;
(c)—a ternary copolymer obtained by copolymerization of ethylene and of an α-olefin containing from 3 to 6 carbon atoms with a non-conjugated diene monomer containing from 6 to 12 carbon atoms, for instance the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art will understand that the present invention is preferably implemented with essentially unsaturated diene elastomers, in particular of the above type (a) or (b).

The diene elastomers may have any microstructure, which depends on the polymerization conditions used, especially on the presence or absence of a modifying and/or randomizing agent and on the amounts of modifying and/or randomizing agent employed. The diene elastomers may, for example, be block, random, sequential or microsequential elastomers and may be prepared in dispersion or in solution; they may be coupled and/or star-branched or else functionalized with a coupling and/or star-branching or functionalization agent. For coupling to a reinforcing inorganic filler such as silica, mention may be made, for example, of silanol or polysiloxane functional groups bearing a silanol end (as described, for example, in FR 2 740 778 or U.S. Pat. No. 6,013,718, and WO 2008/141702), alkoxysilane groups (as described, for example, in FR 2 765 882 or U.S. Pat. No. 5,977,238), carboxyl groups (as described, for example, in WO 01/92402 or U.S. Pat. No. 6,815,473, WO 2004/096865 or US 2006/0089445) or else polyether groups (as described, for example, in EP 1 127 909 or U.S. Pat. No. 6,503,973, WO 2009/000750 and WO 2009/000752).

As functional diene elastomers, mention may also be made of those prepared using a functional initiator, especially those bearing an amine or tin function (see, for example, WO 2010/072761).

Mention may also be made, as other examples of functionalized diene elastomers, of elastomers (such as BR, NR or IR) of the epoxidized type.

For the purposes of the present invention, the term “predominantly” means that the compound is predominant among the compounds of the same type in the composition, that is to say that it is the one which represents the greatest amount by mass among the compounds of the same type. In other words, the mass of this compound represents at least 51% of the total mass of the compounds of the same type in the composition. By way of example, in a system comprising just one elastomer, the latter is predominant within the meaning of the present invention; and in a system comprising two elastomers, the predominant elastomer represents more than half of the total mass of the elastomers, in other words the mass of this elastomer represents at least 51% of the total mass of the elastomers. In the same way, a “predominant” filler is the one representing the greatest mass among the fillers of the composition. In other words, the mass of this filler represents at least 51% of the total mass of the fillers in the composition.

The term “minor” refers to a compound which does not represent the greatest fraction by mass among the compounds of the same type.

All the glass transition temperature “Tg” values are measured in a known manner by DSC (Differential Scanning calorimetry) according to the standard ASTM D3418 (1999).

The term “free of compound X” means that compound X is not detectable by measures known to a person skilled in the art or that this compound X is present in small amounts that represent impurities (i.e. of the order of ppm (parts per million by weight)).

Within the context of the invention, the carbon-based products mentioned in the description may be of fossil or biosourced origin. In the latter case, they may partially or completely result from biomass or be obtained from renewable starting materials derived from biomass. The compounds (such as monomers, polymers), the reagents and other components mentioned in the description, such as the plasticizing agents, fillers, etc., are concerned in particular.

### Copolymer Based on Styrene and Butadiene

The elastomeric matrix of the rubber composition of the tire in accordance with the invention predominantly comprises a copolymer based on styrene and butadiene having a glass transition temperature Tg strictly above −65° C. and below or equal to −30° C. In other words, the mass of the copolymer based on styrene and butadiene having a glass transition temperature Tg strictly above −65° C. and below or equal to −30° C. represents at least 51% of the total mass of the elastomeric matrix.

The term “copolymer based on styrene and butadiene” means herein a copolymer of at least one styrene monomer and of at least one butadiene monomer (and, of course, also any mixture of such copolymers) having a glass transition temperature Tg strictly above −65° C. and below or equal to −30° C.; in other words, said copolymer based on styrene and butadiene includes, by definition, at least styrene units (derived from the styrene monomer) and butadiene units (derived from the butadiene monomer) and has a glass transition temperature Tg strictly above −65° C. and below or equal to −30° C.

The following are suitable in particular as butadiene monomers: 1,3-butadiene, 2-methyl-1,3-butadiene, 2,3-di(C₁-C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene.

The following are suitable in particular as styrene monomers: styrene, methylstyrenes, para-tert-butylstyrene, methoxystyrenes or chlorostyrenes.

Among the copolymers based on styrene and butadiene, mention may be made especially of those with a styrene content of between 5% and 60% by weight and more particularly between 20% and 50% by weight relative to the weight of the copolymer, a molar content (mol %) of 1,2-bonds of the butadiene part of between 4% and 75%, and a molar content (mol %) of trans-1,4-bonds of the butadiene part of between 10% and 80%. The weight content of styrene, the molar content of 1,2-bonds of the butadiene part and the molar content of trans-1,4-bonds are measured by techniques well known to those skilled in the art.

In one embodiment, the copolymer based on styrene and butadiene is constituted of styrene monomers and of butadiene monomers, i.e. the sum of the molar percentages of styrene monomers and of butadiene monomers is equal to 100%.

In the rest of the description, for the sake of simplicity, the expression “copolymer based on styrene and butadiene” is used to denote a copolymer comprising styrene monomers and butadiene monomers or a copolymer constituted of styrene monomers and of butadiene monomers.

The copolymer based on styrene and butadiene may have any microstructure which depends on the polymerization conditions used.

Preferably, the copolymer based on styrene and butadiene may be obtained by solution polymerization. It will advantageously be noted that the rubber composition of the tire in accordance with the invention may not comprise, or may comprise in a very small amount, an extended copolymer based on styrene and butadiene; in other words, the content of extended copolymer based on styrene and butadiene, if this type of copolymer is present, may be less than or equal to 2 phr, so that this content may preferably correspond to an impurity. More particularly, the rubber composition of the tire in accordance with the invention may be free of extended copolymer based on styrene and butadiene. The term “extended copolymer” means a copolymer extended and stabilized with an oil, in particular of paraffinic, naphthenic or aromatic type.

Preferably, the glass transition temperature Tg of the copolymer based on styrene and butadiene may range from −60° C. to −40° C. A person skilled in the art knows how to modify the microstructure of a copolymer based on styrene and butadiene in order to adjust its Tg, in particular by varying the contents of styrene, of 1,2-bonds of the butadiene part or else of trans-1,4-bonds of the butadiene part.

Preferentially, the content of the copolymer based on styrene and butadiene in the rubber composition of the tire in accordance with the invention may range from 51 to 100 phr, preferably from 60 to 100 phr, even more preferably 60 to 85 phr.

The copolymer based on styrene and butadiene may advantageously be used as a blend (mixture) with one or more other diene elastomers different from said copolymer based on styrene and butadiene. In the case of a blend, it is in particular understood that the sum of the various elastomers used is equal to 100 phr.

Thus, in one embodiment of the tire in accordance with the invention, the copolymer based on styrene and butadiene above may optionally be combined with at least one second diene elastomer, different from said copolymer based on styrene and butadiene; that is to say that the second diene elastomer does not include any units derived from styrene and from butadiene. When it is present, the second diene elastomer may be chosen from the group consisting of polybutadienes (BRs), natural rubber (NR), synthetic isoprenes (IRs), butadiene copolymers other than butadiene-styrene copolymers, isoprene copolymers, and mixtures of these polymers and copolymers. Preferably, said second diene elastomer may be a polybutadiene (BR). When it is present, the content of the second diene elastomer may be at most equal to 49 phr, preferentially at most equal to 35 phr. Preferably, the content of the second diene elastomer may range from 5 to 49 phr (as a reminder, the term “phr” means parts by weight per hundred parts of elastomer, that is to say of the total of the elastomers present in the tread), preferably from 15 to 35 phr.

In another embodiment of the tire in accordance with the invention, the copolymer based on styrene and butadiene may optionally be combined with at least one second diene elastomer, different from said copolymer based on styrene and butadiene (that is to say not including any units derived from styrene and from butadiene) and a third elastomer different from said copolymer based on styrene and butadiene and from the second diene elastomer. Preferably, the third diene elastomer may be an isoprene elastomer. Preferentially, the second diene elastomer may be chosen from the group consisting of polybutadienes (BRs) and butadiene copolymers other than butadiene-styrene copolymers; and the third diene elastomer may be chosen from the group consisting of natural rubber (NR), synthetic isoprenes (IRs), isoprene copolymers, and mixtures of these polymers and copolymers. Preferably, the second diene elastomer may be butadiene and the third diene elastomer may be natural rubber or a synthetic isoprene. Preferentially, the content of the second elastomer may range from 0.5 to 35 phr and the content of the third elastomer may range from 0.5 to 35 phr; more preferably the content of the second elastomer may range from 9 to 31 phr and the content of the third elastomer may range from 4 to 24 phr.

Among the polybutadienes or butadiene copolymers used in the above blends, the ones that are particularly suitable for use are polybutadienes with a content (mol %) of 1,2-units of between 4% and 80% or those with a content (mol %) of cis-1,4-units of greater than 80%, more particularly greater than 90%, butadiene-isoprene copolymers and especially those with an isoprene content of between 5% and 90% by weight and a Tg of −40° C. to −80° C., or isoprene-styrene copolymers and especially those with a styrene content of between 5% and 50% by weight and a Tg of between −25° C. and −50° C. In the case of butadiene-styrene-isoprene copolymers, the ones that are especially suitable for use are those with a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2-plus 3,4-units of the isoprene part of between 5% and 70% and a content (mol %) of trans-1,4-units of the isoprene part of between 10% and 50%, and more generally any butadiene-styrene-isoprene copolymer with a Tg of between −20° C. and −70° C.

Among the isoprene elastomers (i.e., isoprene homopolymers or copolymers) used in the above blends, mention will be made in particular of NR, IR or isoprene copolymers, such as isobutene-isoprene (butyl rubber or IIR), isoprene-styrene (SIR), isoprene-butadiene (BIR) or isoprene-butadiene-styrene (SBIR) copolymers. Among the synthetic polyisoprenes, use may preferably be made of polyisoprenes with a content (mol %) of cis-1,4-bonds of greater than 90%, even more preferentially greater than 98%.

The diene elastomers described previously may also be combined, in a minority amount, with synthetic elastomers other than diene elastomers, or even polymers other than elastomers, for example thermoplastic polymers.

### Agent for Modifying the Copolymer Based on Styrene and Butadiene

As mentioned previously, the rubber composition used in the tires of the invention includes at least one agent for modifying said copolymer based on styrene and butadiene, optionally already grafted onto said copolymer, said modifying agent being a 1,3-dipolar compound of general formula (I):

A-E-D (I)
the symbol D represents a functional group comprising at least one nitrogen atom and being capable of bonding to said copolymer via a cycloaddition of [3+2] type on a carbon-carbon double bond of the chain of said copolymer,
the symbol E represents a divalent spacer group connecting the functional group D to the functional group A,
A represents a functional group chosen from C₁-C₂₀ alkyls, C₇-C₁₈ alkylaryls, C₇-C₁₈ arylalkyls, optionally substituted nitrogen-based heterocycles of 5 to 6 atoms, optionally substituted sulfur-based heterocycles of 5 to 6 atoms, ester groups, phosphate groups, dialkylamino groups and associative groups comprising at least one nitrogen atom.

For the purposes of the present invention, the term “modifying agent” means an electrically neutral chemical compound bearing at least one dipole, that is to say a positive charge and a negative charge in one of their main canonical formulae, and capable of forming a [1,3] dipolar cycloaddition on an unsaturated carbon-carbon bond. In other words, the modifying agent is a 1,3-dipolar compound. A person skilled in the art may refer to the definition given for this compound by the IUPAC (International Union of Pure And Applied Chemistry) in the glossary of class names of organic compounds and reactive intermediates based on the structure (IUPAC Recommendations 1995, PAC, 1995, 67, 1307).

The functional group D comprises at least one nitrogen atom and is capable of bonding to the chain of the copolymer based on styrene and butadiene via a cycloaddition of [3+2] type on a carbon-carbon double bond of the chain of said copolymer.

Preferably, the functional group D comprises a nitrile oxide function, a nitrone function or a nitrile imine function.

For the purposes of the present invention, the term “nitrile oxide” means a dipole corresponding to the formula —C≡N→O, including the mesomeric forms thereof.

For the purposes of the present invention, the term “nitrile imine” means a dipole corresponding to the formula —C═N→N, including the mesomeric forms thereof.

For the purposes of the present invention, the term “nitrone” means a dipole corresponding to the formula —C═N(→O)—, including the mesomeric forms thereof.

Preferably, the functional group D comprises a nitrile oxide function.

Preferably, the functional group D comprises a nitrile oxide function and is a group of formula (II):

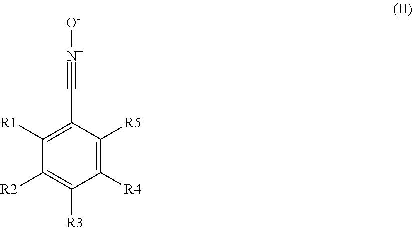

in which:
R1, R2, R3, R4, R5, which may be identical or different, represent a hydrogen atom, a halogen atom, a C₁-C₅ alkyl, a C₁-C₅ alkoxyl or a covalent bond enabling attachment to the spacer group E;
on condition that at least one from among R1, R2, R3, R4 and R5 represents said covalent bond.

Among the ester groups, those corresponding to the formula C(O)—O—R6 with R6 representing a C₁-C₂₀ hydrocarbon-based group, preferably a C₁-C₁₂ hydrocarbon-based group, more preferably representing a C₁-C₆ hydrocarbon-based group, may especially be suitable for use. Preferably, R6 is a C₁-C₆ alkyl, more preferably R6 is a methyl or an ethyl.

Among the phosphate groups, those corresponding to the formula —O—P(O)(OR7)(OR8) with R7 and R8, which may be identical or different, representing a hydrogen atom, an alkyl, an aryl or an alkylaryl, may especially be suitable for use. Preferably, R7 and R8 are identical and are a C₁-C₁₂ alkyl, preferably a C₁-C₆ alkyl, preferably a methyl or an ethyl.

Among the dialkylamino groups, those corresponding to the formula —NR9R10 in which R9 and R10, which may be identical or different, represent a C₁-C₆ alkyl, may especially be suitable for use. Mention may be made, for example, of an N,N-dimethylamino group, an N,N-diethylamino group, or an N-ethyl-N-propylamino group. Preferably, R9 and R10 are identical and are a methyl.

The term “associative group comprising at least one nitrogen atom” means groups that are capable of associating with each other via hydrogen, ionic and/or hydrophobic bonds and which comprises one or more nitrogen atoms. They are especially groups that are capable of associating via hydrogen bonds.

When the associative groups are capable of associating via hydrogen bonds, each associative group includes at least one donor “site” and one site which is an acceptor with regard to the hydrogen bond, so that two identical associative groups are self-complementary and can associate together by forming at least two hydrogen bonds.

The associative groups according to the invention are also capable of associating via hydrogen, ionic and/or hydrophobic bonds with functions present on fillers present in the composition.

The spacer group E is a divalent group which allows at least one functional group D and/or at least one functional group A to be connected, especially when the functional group A is an associative group, and may thus be of any type known per se. However, the spacer group E must not interfere, or must do so only very little, with the functional groups D and A, especially when the functional group A is an associative group, of the modifying agent.

Said spacer group E is thus regarded as a divalent group which is inert with regard to the functional group D. The spacer group E is preferably a linear, branched or cyclic hydrocarbon-based chain, which may contain one or more aromatic radicals and/or one or more heteroatoms. Said chain may optionally be substituted, provided that the substituents are inert with regard to the functional groups D.

According to a preferred embodiment, the spacer group E is a linear or branched C₁-C₂₄, preferably C₁-C₁₀, alkyl chain and more preferentially a linear C₁-C₆ alkyl chain, optionally comprising one or more heteroatoms chosen from nitrogen, sulfur and oxygen atoms.

The compounds according to the invention including a functional group D, a spacer group E and a functional group A, especially an associative group, may be represented, for example, by formula (IIIa) below:

A-E-D (IIIa)

The compounds according to the invention including a functional group D, a spacer group E and two functional groups A, especially two associative groups, may be represented, for example, by formula (IIIb) below:

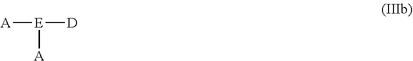

Similarly, the compounds according to the invention including two functional groups D, a spacer group E and a functional group A, especially an associative group, may be represented, for example, by formula (IIIc) below:

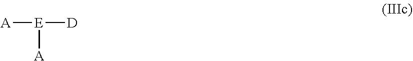

According to the same principle, the compounds according to the invention including two functional groups D, a spacer group E and two functional groups A, especially two associative groups, may be represented, for example, by formula (IIId) below:

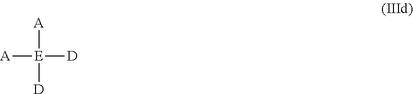

Preferably, the functional group A is an associative group comprising at least one nitrogen atom and is chosen from formulae (IV) to (VIII) below:

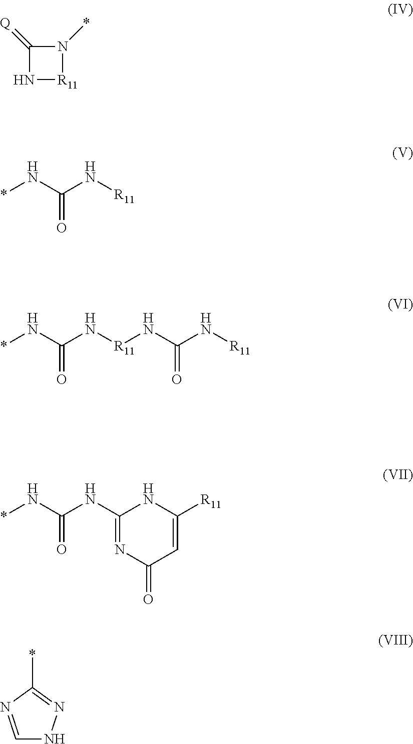

in which:
R11 represents a hydrocarbon-based group that may optionally contain heteroatoms,
Q represents an oxygen or sulfur atom or NH, preferably an oxygen atom, and
the symbol * represents the attachment to the spacer group E.

Preferably, the modifying agent to be grafted or which is grafted onto the copolymer based on styrene and butadiene may be chosen from compounds (IX) to (XVIII) below:

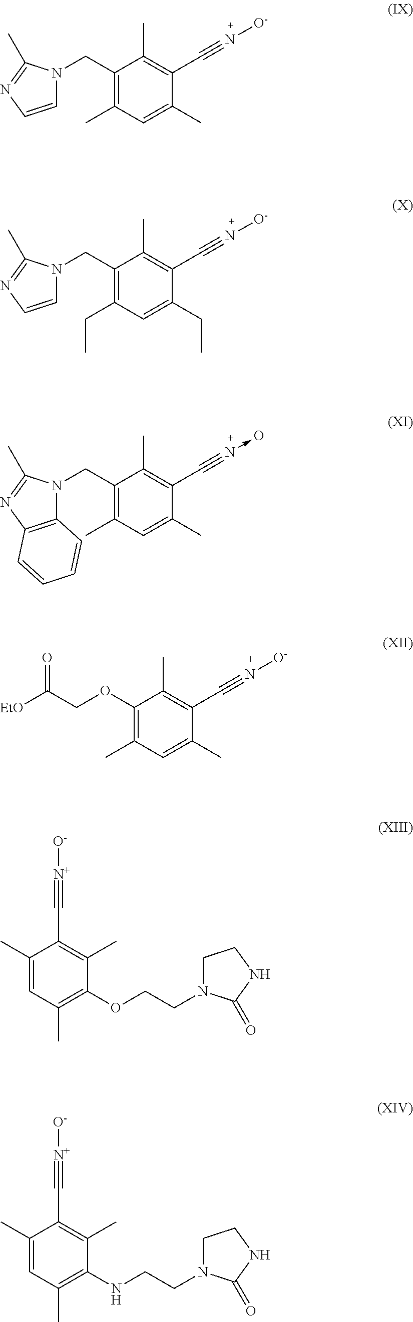

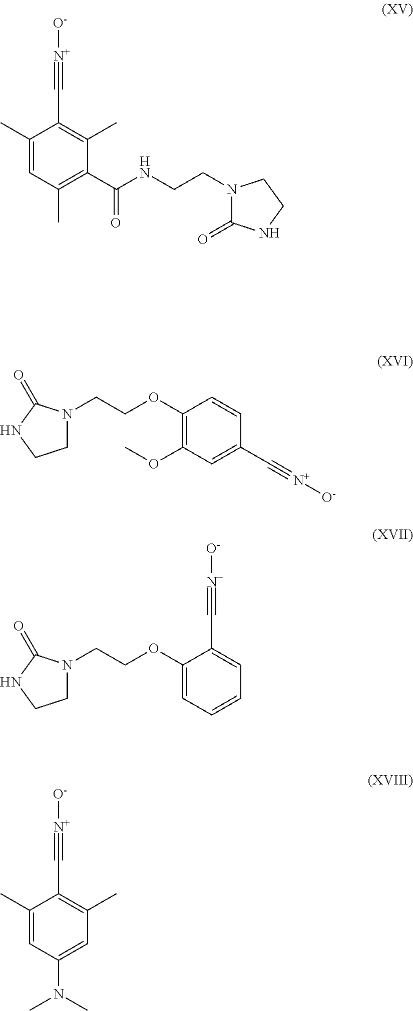

Even more preferably, the modifying agent is chosen from the compounds of formulae (XIII), (XIV), (XV) and (XVII) above and the mesomeric forms thereof.

The modifying agents of general formula (I) that are useful for the invention, if they are not commercially available, may be prepared via any means known to those skilled in the art. For example, use may be made of a synthetic process described in WO 2012/007441.

In the remainder of the text, the term “content of modifying agent” present in a rubber composition, expressed as molar percentage, means the number of molecules of said modifying agent present in the composition per hundred units of the copolymer based on styrene and butadiene of the composition, regardless of whether they are diene or non-diene units.

For example, if the content of modifying agent on the copolymer based on styrene and butadiene is 0.20 mol %, this means that there will be 0.20 unit derived from modifying agent per 100 styrene and butadiene units of said copolymer.

Preferably, the content of modifying agent ranges from 0.01 to 50 mol %, preferably from 0.01 to 5 mol %.

The grafting of the copolymer based on styrene and butadiene with a glass transition temperature Tg strictly above −65° C. and below or equal to −30° C. takes place by reacting said copolymer with the functional group(s) D borne by the modifying agent as defined above. During this reaction, this or these functional groups D form covalent bonds with the elastomer chain.

More precisely, the grafting of said modifying agent is performed by [3+2] cycloaddition of the functional group(s) D of the modifying agent as defined above and one or more carbon-carbon double bonds of the chain of the copolymer based on styrene and butadiene. The cycloaddition mechanism is well known to those skilled in the art and may be illustrated by the following general reaction schemes:
Cycloaddition of a nitrile oxide to an unsaturation or double bond of the polymer (in this instance an isoprene unit)

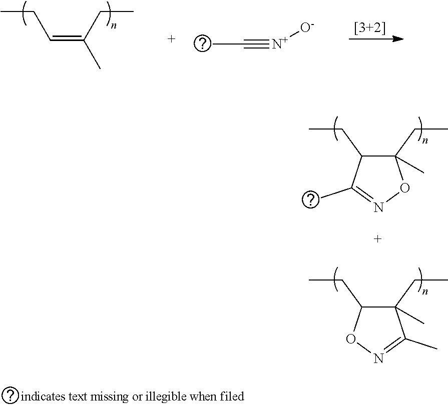

Cycloaddition of a nitrone to an unsaturation or double bond of the polymer (in this instance an isoprene unit)

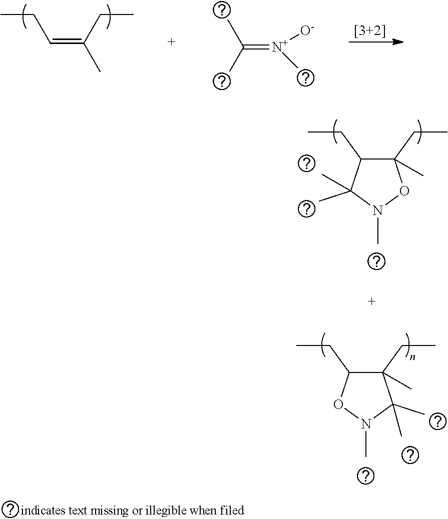

Cycloaddition of a nitrile imine to an unsaturation or double bond of the polymer (in this instance an isoprene unit)

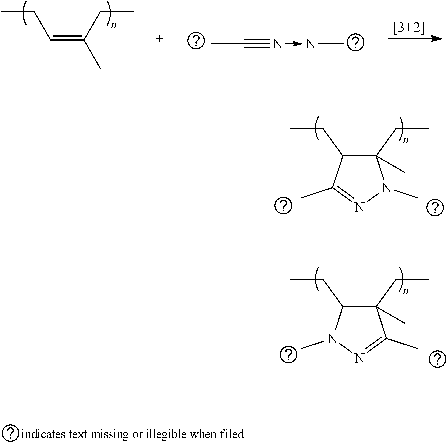

The modifying agent of formula (I) as defined above (or the preferred modifying agents) may be grafted in bulk, for example in an internal mixer or an external mixer, such as an open mill. The grafting is then performed either at a temperature of the external mixer or of the internal mixer of less than 60° C., followed by a step of a grafting reaction under a press or in an oven at temperatures ranging from 80° C. to 200° C., or at a temperature of the external mixer or of the internal mixer of greater than 60° C., without subsequent heat treatment.

The grafting process may also be performed in solution, continuously or batchwise. The copolymer thus modified may be separated from its solution by any type of means known to those skilled in the art and in particular by a steam stripping operation.

### Reinforcing Filler

The rubber composition used in the tires of the invention includes at least one reinforcing filler predominantly comprising silica, that is to say that the mass of silica represents at least 51% of the total mass of the constituents of the reinforcing filler. Preferably, the mass of silica represents more than 60%, preferably more than 70% of the total mass of the reinforcing filler.

In the present specification, the BET specific surface area is determined in a known manner by gas adsorption using the Brunauer-Emmett-Teller method described in The Journal of the American Chemical Society, Vol. 60, page 309, February 1938, more specifically according to French standard NF ISO 9277 of December 1996 (volumetric (5 point) method—gas: nitrogen—degassing: 1 hour at 160° C.—relative pressure p/po range: 0.05 to 0.17). The CTAB specific surface area is the external surface area determined according to French standard NF T45-007 of November 1987 (method B).

The term “reinforcing inorganic filler” should be understood here as meaning any inorganic or mineral filler, regardless of its colour and its origin (natural or synthetic), also known as “white filler”, “clear filler” or even “non-black filler”, in contrast to carbon black; this inorganic filler being capable of reinforcing by itself alone, without means other than an intermediate coupling agent, a rubber composition intended for the manufacture of tires, in other words capable of replacing, in its reinforcing role, a conventional tire-grade carbon black. Such a filler is generally characterized, in a known manner, by the presence of hydroxyl (—OH) groups at its surface, requiring, in order to be used as reinforcing filler, the use of a coupling agent or system intended to provide a stable chemical bond the filler and the elastomer matrix.

Mineral fillers of the siliceous type, preferentially silica (Sift), are especially suitable for use as inorganic reinforcing fillers. The silica used may be any reinforcing silica known to a person skilled in the art, in particular any precipitated or fumed silica with a BET specific surface area and also a CTAB specific surface area both of less than 450 m²/g, preferably from 30 to 400 m²/g, in particular between 60 and 300 m²/g. As highly dispersible precipitated silicas (“HDSs”), mention will be made, for example, of the Ultrasil 7000 and Ultrasil 7005 silicas from the company Evonik, the Zeosil 1165MP, 1135MP and 1115MP silicas and also the Zeosil Premium 200 silica from the company Solvay, the Hi-Sil EZ150G silica from the company PPG, the Zeopol 8715, 8745 and 8755 silicas from the company Huber or the silicas with a high specific surface area as described in patent application WO03/016837.

Needless to say, the term “reinforcing inorganic filler” is also understood to mean mixtures of various reinforcing inorganic fillers, in particular of highly dispersible silicas as described above or a mixture of inorganic fillers of siliceous type and of non-siliceous inorganic fillers. As non-siliceous inorganic fillers, mention may be made of mineral fillers of the aluminous type, in particular of alumina (Al₂O₃) or aluminium (oxides)hydroxides, or else reinforcing titanium oxides, for example described in U.S. Pat. Nos. 6,610,261 and 6,747,087. The non-siliceous inorganic fillers, when present, are in a minority amount in the reinforcing filler.

The physical state in which the inorganic reinforcing filler is provided is not important, whether it is in the form of a powder, of micropearls, of granules or else of beads.

According to one embodiment, the content of the reinforcing filler, in the rubber composition of the tire in accordance with the invention may range from 55 phr to 200 phr, preferably from 55 to 150 phr, more preferably ranges from 55 to 80 phr. These preferential ranges apply to any one of the embodiments of the invention.

A person skilled in the art will understand that use might be made, as filler equivalent to the reinforcing inorganic filler described in the present section, of a reinforcing filler of another nature, in particular organic nature, such as carbon black, provided that this reinforcing filler is covered with an inorganic layer, such as silica, or else includes, at its surface, functional sites, especially hydroxyl sites, requiring the use of a coupling agent in order to establish the bond between the filler and the elastomer. By way of example, mention may be made, for example, of carbon blacks for tires, as described, for example, in patent documents WO 96/37547 and WO 99/28380.

### Carbon Black:

According to one embodiment of the tire in accordance with the invention, the rubber composition may also comprise carbon black.

Carbon black, when it is present, may preferably be used at a content of less than or equal to 10 phr, preferably less than or equal to 5 phr. Preferably, the content of carbon black may range from 0.5 to 4 phr. These preferential ranges apply to any of the embodiments of the invention.

Any carbon black, especially the blacks conventionally used in tires or their treads (“tire-grade” blacks), are suitable for use as carbon blacks. Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. These carbon blacks may be used in isolated form, as commercially available, or in any other form, for example as support for some of the rubber additives used.

### The Coupling Agents

To couple the reinforcing inorganic filler with the elastomer matrix (i.e. to the copolymer based on styrene and butadiene modified with the modifying agent and to the diene elastomers, when they are present), use may be made, in a well-known manner, of an at least difunctional coupling agent (or bonding agent) intended to provide a satisfactory connection, of chemical and/or physical nature, between the inorganic filler (surface of its particles) and the elastomer matrix. Use may be made in particular of at least difunctional organosilanes or polyorganosiloxanes.

Use may be made especially of silane polysulfides, referred to as “symmetrical” or “asymmetrical” depending on their specific structure, as described, for example, in patent applications WO 03/002648 (or US 2005/016651) and WO 03/002649 (or US 2005/016650).

Suitable for use in particular, without the definition below being limiting, are silane polysulfides corresponding to the general formula (XVIII) below:

Z—B—Sₓ—B—Z (XVIII)

in which:
x is an integer from 2 to 8 (preferably from 2 to 5);
the symbols B, which may be identical or different, represent a divalent hydrocarbon-based radical (preferably a C₁-C₁₈ alkylene group or a C₆-C₁₂ arylene group, more particularly a C₁-C₁₀, especially C₁-C₄, alkylene, in particular propylene);
the symbols Z, which may be identical or different, correspond to one of the three formulae below:

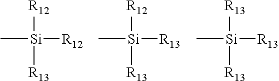

in which:
   the radicals R₁₂, which may be substituted or unsubstituted and identical to or different from each other, represent a C₁-C₁₈ alkyl group, C₅-C₁₈ cycloalkyl group or C₆-C₁₈ aryl group (preferably C₁-C₆ alkyl, cyclohexyl or phenyl groups, especially C₁-C₄ alkyl groups, more particularly methyl and/or ethyl).
   the radicals R₁₃, which may be substituted or unsubstituted and identical to or different from each other, represent a C₁-C₁₈ alkoxyl group or C₅-C₁₈ cycloalkoxyl group (preferably a group chosen from C₁-C₈ alkoxyls and C₅-C₈ cycloalkoxyls, even more preferentially a group chosen from C₁-C₄ alkoxyls, in particular methoxyl and ethoxyl).

In the case of a mixture of alkoxysilane polysulfides corresponding to the above formula (XVIII), especially normal commercially available mixtures, the mean value of the “x” indices is a fractional number preferably between 2 and 5, more preferentially close to 4. However, the invention may also advantageously be performed, for example, with alkoxysilane disulfides (x=2).

As examples of silane polysulfides, mention will be made more particularly of bis((C₁-C₄)alkoxyl(C₁-C₄)alkylsilyl(C₁-C₄)alkyl) polysulfides (especially disulfides, trisulfides or tetrasulfides), for instance bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. Mention will also be made, as preferential examples, of bis(mono(C₁-C₄)alkoxyldi(C₁-C₄)alkylsilylpropyl) polysulfides (especially disulfides, trisulfides or tetrasulfides), more particularly bis(monoethoxydimethylsilylpropyl) tetrasulfide, as described in the abovementioned patent application WO 02/083782 (or U.S. Pat. No. 7,217,751).

As examples of coupling agents other than an alkoxysilane polysulfide, mention will be made especially of difunctional POSs (polyorganosiloxanes) or hydroxysilane polysulfides (R²═OH in the above formula (XVIII)) as described, for example, in patent applications WO 02/30939 (or U.S. Pat. No. 6,774,255), WO 02/31041 (or US 2004/051210), and WO 2007/061550, or else silanes or POSs bearing azodicarbonyl functional groups, as described, for example, in patent applications WO 2006/125532, WO 2006/125533, WO 2006/125534.

As examples of other silane sulfides, mention will be made, for example, of silanes bearing at least one thiol (—SH) function (referred to as mercaptosilanes) and/or at least one masked thiol function, as described, for example, in patents or patent applications U.S. Pat. No. 6,849,754, WO 99/09036, WO 2006/023815, WO 2007/098080, WO 2010/072685 and WO 2008/055986.

Needless to say, use could also be made of mixtures of the coupling agents described previously, as described especially in the abovementioned patent application WO 2006/125534.

The content of coupling agent is advantageously less than 20 phr, it being understood that it is generally desirable to use as little as possible thereof. Typically, the content of coupling agent represents from 0.5% to 15% by weight relative to the amount of inorganic filler. Its content is preferentially between 0.5 and 12 phr, more preferentially within a range extending from 3 to 10 phr. This content is readily adjusted by a person skilled in the art depending on the content of inorganic filler used in the composition. These preferential ranges apply to any of the embodiments of the invention.

### The Covering Agents:

These compositions may also contain, in addition to the coupling agents, coupling activators, agents for covering the inorganic fillers or more generally processing aids capable, in a known manner, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

### Plasticizing System

The rubber composition of the tires in accordance with the invention comprises from 2 to 17 phr of a plasticizing system, this system comprising from 2 to 15 phr of at least one plasticizing resin with a glass transition temperature Tg of greater than or equal to 20° C., and preferably from 0 to 2 phr of a plasticizing agent that is liquid at room temperature.

As is known to a person skilled in the art, the term “resin” is reserved in the present patent application, by definition, for a compound which is solid at room temperature (23° C.), in contrast with a plasticizing agent that is liquid at room temperature such as an oil.

Plasticizing resins are polymers that are well known to those skilled in the art. These are hydrocarbon-based resins essentially based on carbon and hydrogen, but which may include other types of atoms, which can be used in particular as plasticizing agents or tackifying agents in polymer matrices. They are by nature miscible (i.e. compatible) at the contents used with the compositions of diene elastomer(s) for which they are intended, so as to act as true diluents. They have been described, for example, in the publication entitled “Hydrocarbon Resins” by R. Mildenberg, M. Zander and G. Collin (New York, VCH, 1997, ISBN 3-527-28617-9), Chapter 5 of which is devoted to their applications, in particular in the tire rubber field (5.5. “Rubber Tires and Mechanical Goods”). They may be aliphatic, cycloaliphatic, aromatic, hydrogenated aromatic, or of the aliphatic/aromatic type, that is to say based on aliphatic and/or aromatic monomers. They may be natural or synthetic and are or are not based on petroleum (if such is the case, they are also known as petroleum resins). Their Tg is preferably greater than 0° C., in particular greater than 20° C. (most often between 30° C. and 95° C.).

In a known manner, these plasticizing resins may also be described as thermoplastic resins in the sense that they soften when heated and can thus be moulded. They may also be defined by a softening point or temperature. The softening point of a plasticizing resin is generally about 50 to 60° C. above its Tg value. The softening point is measured according to the standard ISO 4625 (ring and ball method). The macrostructure (Mw, Mn and PDI) is determined by size exclusion chromatography (SEC) as indicated below.

As a reminder, SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a “Waters Alliance” chromatographic line according to the following conditions: elution solvent: tetrahydrofuran; temperature 35° C.; concentration 1 g/litre; flow rate: 1 ml/min; volume injected: 100 μl; Moore calibration with polystyrene standards; set of 3 “Waters” columns in series (“Styragel HR4E”, “Styragel HR1” and “Styragel HR 0.5”); detection by differential refractometer (for example, “Waters 2410”) which can be equipped with operating software (for example, “Waters Millenium”).

A Moore calibration is performed with a series of commercial polystyrene standards having a low PDI (less than 1.2), with known molar masses, covering the range of masses to be analysed. The mass-average molar mass (Mw), the number-average molar mass (Mn) and the polydispersity index (PDI=Mw/Mn) are deduced from the data recorded (curve of distribution by mass of the molar masses). All the molar mass values indicated in the present patent application are thus relative to calibration curves produced with polystyrene standards.

According to a preferred embodiment of the invention, the plasticizing resin may have at least any one of the following features:
a Tg of greater than or equal to 20° C. (in particular between 30° C. and 100° C.), more preferentially greater than or equal to 30° C. (in particular between 30° C. and 95° C.);
a softening point of greater than or equal to 40° C. (in particular between 40° C. and 150° C.);
a number-average molar mass (Mn) of between 400 and 2000 g/mol, preferentially between 500 and 1500 g/mol;
a polydispersity index (PDI) of less than 3, preferentially less than 2 (as a reminder: PDI=Mw/Mn with Mw the weight-average molar mass).

More preferentially, the plasticizing resin may have all of the above preferred features.

As examples of such plasticizing resins, mention may be made of those chosen from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, mixtures of C₅ fraction homopolymer or copolymer resins and of C₉ fraction homopolymer or copolymer resins, α-methylstyrene homopolymer or copolymer resins, and mixtures of these resins.

Among the above copolymer resins, mention may be made more particularly of those chosen from the group consisting of CPD/vinylaromatic copolymer resins, DCPD/vinylaromatic copolymer resins, CPD/terpene copolymer resins, DCPD/terpene copolymer resins, terpene/phenol copolymer resins, CPD/C₅ fraction copolymer resins, DCPD/C₅ fraction copolymer resins, CPD/C₉ fraction copolymer resins, DCPD/C₉ fraction copolymer resins, mixtures of C₅ fraction and C₉ fraction resins, terpene/vinylaromatic copolymer resins, terpene/phenol copolymer resins, C₅ fraction/vinylaromatic copolymer resins, and mixtures of these resins.

The term “terpene” groups together here, in a known manner, α-pinene, β-pinene and limonene monomers; use is preferentially made of a limonene monomer, a compound which exists, in a known manner, in the form of three possible isomers: L-limonene (laevorotatory enantiomer), D-limonene (dextrorotatory enantiomer), or else dipentene, the racemate of the dextrorotatory and laevorotatory enantiomers. Suitable as vinylaromatic monomer are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer derived from a C₉ fraction (or more generally from a C₈ to C₁₀ fraction).

More particularly, mention may be made of resins chosen from the group consisting of CPD homopolymer resins, DCPD homopolymer resins, CPD/styrene copolymer resins, DCPD/styrene copolymer resins, polylimonene resins, limonene/styrene copolymer resins, limonene/CPD copolymer resins, limonene/DCPD copolymer resins, C₅ fraction/styrene copolymer resins, C₅ fraction/C₉ fraction copolymer resins, and mixtures of these resins.

All the above resins are well known to a person skilled in the art and are commercially available, for example sold by the company DRT under the name Dercolyte as regards polylimonene resins, by the company Neville Chemical Company under the name Super Nevtac, by Kolon under the name Hikorez or by the company ExxonMobil under the name Escorez as regards C₅ fraction/styrene resins or C₅ fraction/C₉ fraction resins, or else by the company Struktol under the name 40 MS or 40 NS (mixtures of aromatic and/or aliphatic resins).

According to one embodiment of the invention, the plasticizing system may moreover include a plasticizing agent that is liquid at room temperature (at 23° C.) present in a content of less than or equal to 2 phr.

Any extender oil, whether it is of aromatic or non-aromatic nature, or any plasticizing agent that is liquid at room temperature known for its plasticizing properties with regard to diene elastomers may be able to be used in addition to the plasticizing resin. At room temperature (23° C.), these plasticizing agents or these oils, which are more or less viscous, are liquids (that is to say, as a reminder, substances which have the ability to eventually take on the shape of their container), as opposed, in particular, to plasticizing hydrocarbon-based resins, which are by nature solids at room temperature.

As plasticizing agents that are liquid at room temperature, mention may be made especially of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extract oils) oils, TRAE (Treated Residual Aromatic Extract) oils, SRAE (Safety Residual Aromatic Extract oils) oils, mineral oils, vegetable oils, ether plasticizing agents, ester plasticizing agents, phosphate plasticizing agents, sulfonate plasticizing agents, and mixtures of these compounds. According to a more preferred embodiment, the plasticizing agent that is liquid at room temperature is chosen from the group consisting of MES oils, TDAE oils, naphthenic oils, vegetable oils, and mixtures of these oils.

In one embodiment, the rubber composition of tires in accordance with the invention may comprise from 2 to 12 phr of a plasticizing system, this system comprising from 2 to 10 phr of at least one plasticizing resin with a glass transition temperature Tg of greater than or equal to 20° C., and preferably from 0 to 2 phr of a plasticizing agent that is liquid at room temperature (23° C.). The preferred features of the plasticizing resin as described above and the preferred features of the plasticizing agent that is liquid at room temperature, when it is present, apply to this embodiment.

In another embodiment, the rubber composition of tires in accordance with the invention may be free of plasticizing agent that is liquid at room temperature (23° C.). In this case, the rubber composition of tires in accordance with the invention may comprise from 2 to 10 phr of a plasticizing system consisting of from 2 to 10 phr of at least one plasticizing resin with a glass transition temperature Tg of greater than or equal to 20° C.

### Various Additives

The rubber compositions of the tires in accordance with the invention may also include all or some of the usual additives customarily used in elastomer compositions intended to constitute external mixtures of finished rubber articles such as tires, in particular treads, for instance protective agents such as antiozone waxes, for instance paraffin, chemical antiozonants, antioxidants, anti-fatigue agents, pigments.

### Crosslinking System

The crosslinking system is preferentially a vulcanization system, that is to say a system based on sulfur (or on a sulfur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), or else known vulcanization retarders, may be added to this basic vulcanization system, being incorporated during the first non-productive phase and/or during the productive phase, as described subsequently.

When sulfur is used, it is used at a preferential content of between 0.5 and 12 phr, in particular between 1 and 10 phr. These preferential ranges apply to any of the embodiments of the invention. The primary vulcanization accelerator is used at a preferential content of between 0.5 and 10 phr, more preferentially of between 0.5 and 5.0 phr. These preferential ranges apply to any of the embodiments of the invention.

The content of sulfur used in the rubber composition of the tread in accordance with the invention is most often between 0.5 and 3.0 phr, and that of the primary accelerator is between 0.5 and 5.0 phr. These preferential ranges apply to any of the embodiments of the invention.

Use may be made, as (primary or secondary) accelerator, of any compound that is capable of acting as accelerator for the vulcanization of diene elastomers in the presence of sulfur, in particular accelerators of the thiazole type and also derivatives thereof, and accelerators of thiuram and zinc dithiocarbamate types. These accelerators are, for example, chosen from the group consisting of 2-mercaptobenzothiazyl disulfide (abbreviated to MBTS), tetrabenzylthiuram disulfide (TBZTD), N-cyclohexyl-2-benzothiazylsulfenamide (CBS), N,N-dicyclohexyl-2-benzothiazylsulfenamide (DCBS), N-(tert-butyl)-2-benzothiazylsulfenamide (TBBS), N-(tert-butyl)-2-benzothiazylsulfenimide (TBSI), zinc dibenzyldithiocarbamate (ZBEC), and mixtures of these compounds.

### Manufacture of the Composition and of the Tire

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

According to a first embodiment of the invention, the copolymer based on styrene and butadiene as defined above was grafted with the modifying agent of formula (I) as defined above (or the preferred modifying agents as defined above), prior to the manufacture of the rubber composition. Thus, in this case, it is the grafted copolymer based on styrene and butadiene with a glass transition temperature Tg strictly above −65° C. and below or equal to −30° C. which is introduced during the “non-productive” first phase. Thus, according to this first embodiment of the process, said process comprises the following steps:
modifying said copolymer above based on styrene and butadiene in post-polymerization or in solution or in bulk by grafting with a modifying agent of formula (I) as defined above (or the preferred modifying agents as defined above),
incorporating into said copolymer based on styrene and butadiene thus grafted with said modifying agent (or the preferred modifying agents as defined above), the reinforcing filler, the plasticizing system, and all the other base constituents of the composition, with the exception of the chemical crosslinking system, thermomechanically kneading the whole, one or more times, until a maximum temperature of between 130° C. and 200° C., preferably between 145° C. and 185° C., is reached,
cooling the combined mixture to a temperature below 100° C.,
subsequently incorporating the chemical crosslinking agent,
kneading the whole up to a maximum temperature of less than 120° C.,
extruding or calendering the rubber composition thus obtained.

According to a second embodiment of the invention, the grafting of the copolymer based on styrene and butadiene with a glass transition temperature Tg strictly above −65° C. and below or equal to −30° C. with the modifying agent of formula (I) (or the preferred modifying agents as defined above) is performed concomitantly with the manufacture of the rubber composition. In this case, both said copolymer based on styrene and butadiene not yet grafted and the modifying agent of formula (I) (or the preferred modifying agents as defined above) are introduced during the “non-productive” first phase. Preferentially, the reinforcing filler is then added subsequently, during this same non-productive phase, so as to prevent any side reaction with the modifying agent of formula (I) (or with the preferred modifying agents as defined above).

Thus, according to this second embodiment of the process, the latter comprises the following steps:
incorporating into the copolymer based on styrene and butadiene with a glass transition temperature Tg strictly above −65° C. and below or equal to −30° C., a modifying agent of formula (I) (or the preferred modifying agents as defined above) as described above, at a temperature and for a duration such that the grafting yield is preferably greater than 60%, more preferentially greater than 80%, and, preferably subsequently, the reinforcing filler, the plasticizing system and also all the base constituents of the composition, with the exception of the chemical crosslinking system, by thermomechanically kneading the whole, one or more times, until a maximum temperature of between 130° C. and 200° C., preferably between 145° C. and 185° C., is reached,
cooling the combined mixture to a temperature below 100° C.,
subsequently incorporating the chemical crosslinking agent,
kneading the whole up to a maximum temperature of less than 120° C.,
extruding or calendering the rubber composition thus obtained.

The final composition thus obtained may be subsequently calendered, for example in the form of a sheet or slab, especially for laboratory characterization, or else extruded, to form, for example, a rubber profiled element used as a tread of a tire for a vehicle bearing heavy loads, especially for a heavy-duty vehicle or for a civil engineering vehicle.

The tire in accordance with the invention is preferably a tire intended to equip a vehicle bearing heavy loads, such as heavy-duty vehicles, buses, civil engineering vehicles. Preferentially, the tire in accordance with the invention is a tire intended to equip a heavy-duty vehicle.

The tire may be manufactured according to any process well known to a person skilled in the art.

The abovementioned characteristics of the present invention, and also others, will be understood more clearly on reading the following description of several implementation examples of the invention, given by way of illustration and without limitation.

### II—EXAMPLES OF IMPLEMENTATION OF THE INVENTION

### II-1. Measurements and Tests Used

### Dynamic Properties

The dynamic properties and in particular tan(δ)ₘₐₓ, representative of the hysteresis, are measured on a viscosity analyser (Metravib VA4000) according to the standard ASTM D 5992-96. The response is recorded of a sample of the vulcanized composition (cylindrical test specimens with a thickness of 4 mm and a cross section of 400 mm²), subjected to a simple alternating sinusoidal shear stress, at a frequency of 10 Hz.

For the measurement of the modulus G* at 50% strain, noted as G*_{50%}, and of tan(δ)ₘₐₓ, a sweep is performed with a strain amplitude from 0.1% to 100% peak-to-peak (outward cycle), and then from 100% to 0.1% peak-to-peak (return cycle) at a temperature of 60° C. The results made use of are the complex dynamic shear modulus (G*) and the loss factor tan(δ). The maximum value of tan(δ) observed (tan(δ)ₘₐₓ) between the values from 0.1% to 100% strain are shown for the outward cycle.

For the measurement of tan(δ)_{-20° C.}, a temperature sweep is performed, under a stress of 0.7 MPa, and the tan(δ) value observed at −20° C. is recorded.

### II-2. Preparation of the Rubber Compositions

The procedure for the tests which follow is as follows: the non-grafted diene elastomer(s) are introduced into an 85 cm³ Polylab internal mixer, filled to 70%, the initial vessel temperature of which is about 110° C. For the mixtures concerning the invention, the modifying agent of general formula (I) is introduced at the same time as the diene elastomer and thermomechanical working is performed for 1 minute 30 seconds at 25° C., the whole being mixed (productive phase) for about 5 to 6 minutes.

Next, for all the compositions (control compositions and compositions of the invention), the optional reinforcing filler(s), the optional coupling agent and then, after kneading for one to two minutes, the various other ingredients, with the exception of the vulcanization system, are introduced into the mixer. Thermomechanical working is then performed (non-productive phase) in one step (total duration of the kneading equal to about 5 min), until a maximum “dropping” temperature of 160° C. is reached. The mixture thus obtained is recovered and cooled and the vulcanization system (sulfur) is then added on an external mixer (homofinisher) at 25° C., the whole being mixed (productive phase) for about 5 to 6 min.

The compositions thus obtained are subsequently calendered, either in the form of slabs (thickness of 2 to 3 mm) or of thin sheets of rubber, for the measurement of their physical or mechanical properties, or in the form of profiled elements which can be used directly, after cutting and/or assembling to the desired dimensions, for example as semi-finished products for tires, in particular as tire treads.

### II-3. Test A

The aim of this test is to demonstrate the improvement in the compromise of wet grip/rolling resistance/wear strength performance qualities of a composition in accordance with the invention relative to compositions not in accordance with the invention.

To do this, four compositions are compared, which differ from each other essentially in the technical characteristics that follow:
composition T1 is a composition not in accordance with the invention comprising an SBR of Tg=−65° C. without modifying agent of general formula (I);
composition T2 is a composition not in accordance with the invention comprising an SBR of Tg=−48° C. without modifying agent of general formula (I);
composition T3 is a composition not in accordance with the invention comprising an SBR of Tg=−65° C. with a modifying agent of general formula (I);
composition C1 is a composition according to the invention comprising an SBR of Tg=−48° C. with a modifying agent of general formula (I).

Table 1 gives the formulation of the various compositions T1 to T3 and C1; the contents are expressed in phr. All the compositions (T1 to T3 and C1) comprise a crosslinking system conventionally used in the manufacture of tire treads; this crosslinking system comprising, in particular, sulfur, ZnO, stearic acid and an accelerator.

TABLE 1

| | T1 | T2 | T3 | C1 |
|---|---|---|---|---|
| SBR (1) | (—) | 80 | (—) | 80 |
| SBR (2) | 80 | (—) | 80 | (—) |
| BR (3) | 20 | 20 | 20 | 20 |
| Silica (4) | 65 | 65 | 65 | 65 |
| Carbon black (5) | 4 | 4 | 4 | 4 |
| Resin (6) | 10 | 10 | 10 | 10 |
| Modifying agent | (—) | (—) | 1.28 | 1.28 |
| of formula (I) (7) | | | | |
| Coupling agent (8) | 6.5 | 6.5 | 6.5 | 6.5 |
| DPG (9) | 0.9 | 0.9 | 0.9 | 0.9 |
| Antioxidant (10) | 2 | 2 | 2 | 2 |
| Paraffin | 1 | 1 | 1 | 1 |

(1) Non-functional, non-extended solution SBR, with 24% of 1,2-polybutadiene units; 26.5% of styrene units and a Tg = −48° C.;
(2) Non-functional, non-extended solution SBR, with 24% of 1,2-polybutadiene units: 15.5% of styrene units and a Tg = −65° C.;
(3) Neodymium polybutadiene with 98% of cis-1,4-butadiene units and a Tg = −108° C.;
(4) Zeosil 1165MP silica of HDS type from Solvay;
(5) N134 carbon black;
(6) C₅/C₉ fraction resin sold by Cray Valley under the name THER 8644 resin (Tg = 44° C.);
(7) Modifying agent of formula (I): 2,4,6-trimethyl-3-(2-(2-oxoimidazolidin-1-yl)ethoxy)nitrile oxide synthesized according to the protocol described in WO 2012/007441
(8) Coupling agent: TESPT (Si69 from Evonik-Degussa);
(9) Diphenylguanidine (Perkacit DPG from Flexsys);
(10) N-(1,3-dimethylbutyl)-N-phenyl-para-phenylenediamine sold by Flexsys under the name Santoflex 6-PPD.

The properties of the compositions after curing at 150° C. for 45 min are presented in table 2 below.

| | T1 | T2 | T3 | C1 |
|---|---|---|---|---|
| G*50% (MPa) | 2.1 | 1.9 | 2.0 | 1.9 |
| tan(δ)max | 0.185 | 0.190 | 0.154 | 0.170 |
| tan(δ)_{-20° C.} | 0.389 | 0.631 | 0.325 | 0.711 |

From table 2, it is seen, for an equivalent stiffness (G*50% value), that composition T2 not in accordance with the invention comprising an unmodified high-Tg SBR allows, relative to composition T1 not in accordance comprising an unmodified low-Tg SBR, a significant improvement in the wet grip performance (tan(δ)_{-20° C.} value) accompanied by degradation of the rolling resistance performance (tan(δ)ₘₐₓ value). The compromise of wet grip/rolling resistance/wear strength performance qualities is not improved for composition T2 relative to composition T1 not in accordance with the invention.

Moreover, it is found, for an equivalent stiffness, that composition T3 not in accordance with the invention comprising a low-Tg SBR modified with the modifying agent of general formula (I) allows, relative to composition T1 not in accordance comprising an unmodified low-Tg SBR, a significant improvement in the rolling resistance performance, but at the expense of the wet grip performance. The compromise of wet grip/rolling resistance/wear strength performance qualities is not improved for composition T3 relative to composition T1 not in accordance with the invention.

Surprisingly, for equivalent stiffness, it is found that composition C1 in accordance with the invention comprising a high-Tg SBR modified with the modifying agent of general formula (I) allows, relative to composition T1 not in accordance with the invention, a significant improvement both in the rolling resistance performance and in the wet grip performance. Composition C1 in accordance with the invention thus has, surprisingly, an improved compromise of wet grip/rolling resistance/wear strength performance qualities relative to composition T1 not in accordance with the invention.

1. A tire intended to equip a vehicle bearing heavy loads, this tire comprising a tread including at least one rubber composition based on at least:
an elastomer matrix predominantly comprising a copolymer based on styrene and butadiene having a glass transition temperature Tg strictly above −65° C. and below or equal to −30° C.,
a reinforcing filler predominantly comprising silica,
a chemical crosslinking system,
an agent for coupling between the elastomer matrix and the reinforcing filler,
a plasticizing system comprising from 2 to 15 phr, of at least one plasticizing resin having a glass transition temperature Tg of greater than or equal to 20° C., and of which the total content of the plasticizing system in the composition ranges from 2 to 17 phr, and
an agent for modifying said copolymer based on styrene and butadiene, optionally already grafted onto said copolymer, said modifying agent being a 1,3-dipolar compound of general formula (I):
A-E-D (I)
the symbol D represents a functional group comprising at least one nitrogen atom and being capable of bonding to said copolymer via a cycloaddition of [3+2] type on a carbon-carbon double bond of the chain of said copolymer,
the symbol E represents a divalent spacer group connecting group D to group A,
A represents a functional group chosen from C₁-C₂₀ alkyls, C₇-C₁₈ alkylaryls, C₇-C₁₈ arylalkyls, optionally substituted nitrogen-based heterocycles of 5 to 6 atoms, optionally substituted sulfur-based heterocycles of 5 to 6 atoms, ester groups, phosphate groups, dialkylamino groups and associative groups comprising at least one nitrogen atom.

2. A tire according to claim 1, in which the functional group D of the modifying agent comprises a nitrile oxide function, a nitrone function or a nitrile imine function.

3. A tire according to claim 1, in which the spacer group E is a linear or branched C₁-C₂₄ alkyl chain optionally comprising one or more heteroatoms chosen from nitrogen, sulfur and oxygen atoms.

4. A tire according to claim 1, in which the group D of the modifying agent is a group of formula (II): 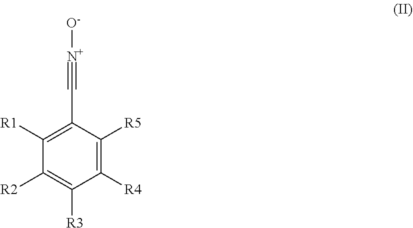
in which:
R1, R2, R3, R4, R5, which may be identical or different, represent a hydrogen atom, a halogen atom, a C₁-C₅ alkyl, a C₁-C₅ alkoxyl or a covalent bond enabling attachment to the spacer group E;
on condition that at least one from among R1, R2, R3, R4 and R5 represents said covalent bond.

5. A tire according to claim 1, in which the group A is an associative group comprising at least one nitrogen atom, said associative group being chosen from formulae (IV) to (VIII) below: 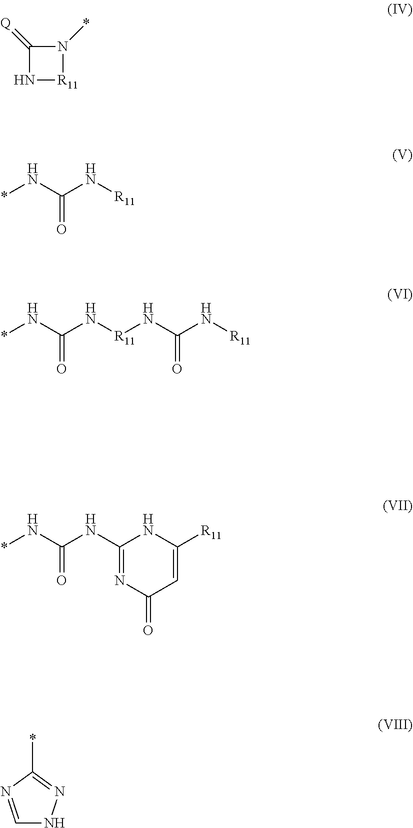
in which:
R11 represents a hydrocarbon-based group that may optionally contain heteroatoms,
Q represents an oxygen or sulfur atom or NH, and
the symbol * represents the attachment to the spacer group E.

6. A tire according to claim 1, in which the modifying agent is chosen from the compounds of formulae (IX) to (XVIII) below and the mesomeric forms thereof:

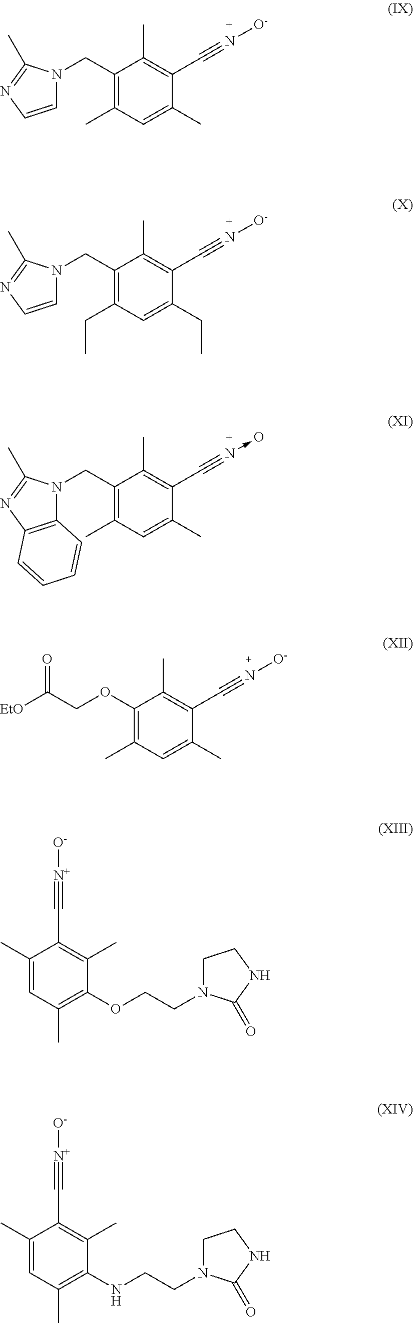

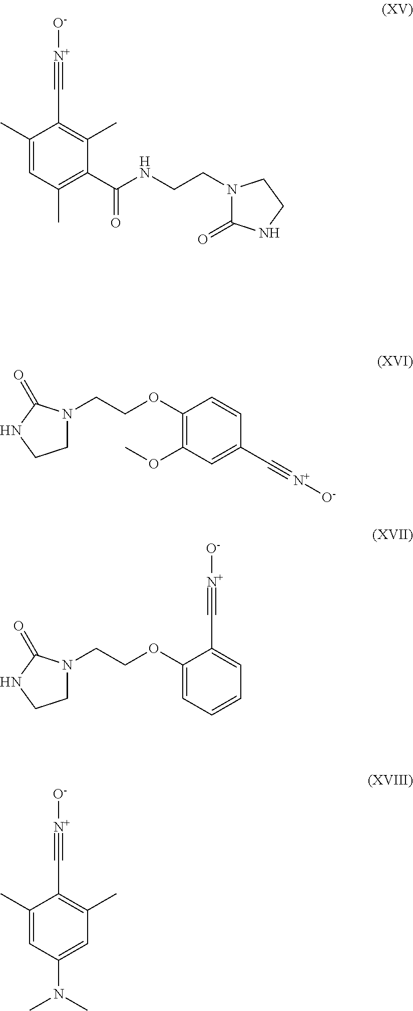

7. A tire according to claim 6, in which the modifying agent is chosen from the compounds of formulae (XIV), (XV), (XVI) and (XVIII) and the mesomeric forms thereof.

8. A tire according to claim 1, in which the content of modifying agent ranges from 0.01 to 50 mol %.

9. A tire according to claim 1, in which the copolymer based on styrene and butadiene has a glass transition temperature ranging from −60 to −40° C.

10. A tire according to claim 1, in which the copolymer based on styrene and butadiene is constituted of styrene monomers and of butadiene monomers.

11. A tire according to claim 1, in which the elastomer matrix further comprises at least one second diene elastomer different from the copolymer based on styrene and butadiene.

12. A tire according to claim 11, in which the second diene elastomer is chosen from the group consisting of polybutadienes, natural rubber, synthetic isoprenes, butadiene copolymers other than butadiene-styrene copolymers, isoprene copolymers, and mixtures of these polymers and copolymers.

13. A tire according to claim 11, in which the content of the second diene elastomer ranges from 5 to 49 phr.

14. A tire according to claim 1, in which the composition also comprises carbon black.

15. A tire according to claim 1, in which the content of the reinforcing filler ranges from 55 to 200 phr.

16. A tire according to claim 1, in which the plasticizing resin has a glass transition temperature Tg of greater than or equal to 30° C.

17. A tire according to claim 1, in which the plasticizing resin is chosen from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, mixtures of C₅ fraction homopolymer or copolymer resins and of C₉ fraction homopolymer or copolymer resins, α-methylstyrene homopolymer or copolymer resins, and mixtures of these resins.

18. A tire according to claim 1, in which the plasticizing system comprises from 0 to 2 phr of at least one plasticizing agent that is liquid at room temperature.

19. A tire according to claim 1, in which the composition is free of a plasticizing agent that is liquid at room temperature.

20. A tire according to claim 1, wherein the tire is intended to equip a heavy-duty vehicle or a bus.
